(19) United States
(12) Patent Application Publication
(10) Pub. No.: US 2008/0144066 A1
(43) Pub. Date: Jun. 19, 2008

(54) Composition Print Method Using Translators

(76) Inventor: Andrew Rodney Ferlitsch, Camas, WA (US)

Correspondence Address: KIRTON & MCCONKIE, 1800 EAGLE GATE TOWER / 60 EAST SOUTH TEMPLE, P.O. BOX 45120, SALT LAKE CITY, UT, 84145-0120, US

(21) Appl. No.: 11/553,279

(22) Filed: Oct. 26, 2006

(51) Int. Cl. G06F 3/12

(52) U.S. Cl. 358/1.13; 358/1.16

(57) ABSTRACT

A method and apparatus is disclosed for receiving, combining, and processing multiple input jobs of multiple formats that may or may not be native to a MFP into a single composed output job in a format native to or compatible with the MFP, which is then outputted. A plurality of jobs is received at the MFP. Then, the jobs are examined to determine which jobs, if any, are in a format native to the MFP, and which jobs, if any, are in a format not native to the MFP. Received jobs which are in formats not native to the MFP are converted into native formats. When all the jobs are in native formats, the jobs are then merged or combined into a single output job and outputted according to settings provided to the MFP.

### BACKGROUND OF THE INVENTION

1. Field of the Invention

The present invention relates to composition printing for a walkup print job, and more particularly to a multifunction peripheral or multifunction printer (commonly known and referred to as a “MFP”) capable of receiving multiple documents and/or files as inputs and combining the inputs into a single print job or output document.

2. Background and Related Art

It is currently possible to process print jobs and other functions at some multifunction peripherals (or “multifunction printers” or “MFPs”) by simply inserting a memory device into a port on the MFP, selecting print options or other options, and processing the job. This process may be known as “hostless printing,” and is advantageous because it allows the MFP to perform some functions without requiring that the MFP be attached to an active local or remote computer host or an active network. Common memory devices compatible with these functions at MFPs include USB mass storage devices (both flash-memory based and magnetic storage based (portable hard disk drives)), floppy disks, and a variety of formats of memory devices or cards for use with common cameras, which may also be flash-memory based or include small hard disk drives. In some instances, a digital camera itself may be connected directly to a MFP to print the photos contained on the camera.

Many MFPs can perform a wide range of functions, including copying, printing, faxing, and scanning, and in some cases many or all of these functions can be performed without having the MFP connected to a network or an active local or remote computer host. Thus MFPs can accept and process softcopy documents contained in files on storage devices or received in a facsimile transmission, or hardcopy documents inputted by scanning or other similar processes.

Reference will now be made to FIG. 1 as an example of a walkup print job performed using a MFP according to the prior art. A user may initiate a walkup print job at a MFP 20, with the print job contained as an electronic file on a hostless storage device 22, such as a digital camera card, which the user connects to the MFP 20. When the user initiates the walkup print job, the MFP 20 retrieves the file to be printed from the storage device 22. The MFP 20 then processes and outputs the converted file according to output options selected by the walkup user via a control panel 26 provided on the MFP 20.

Referring now to FIG. 2, some MFPs 20 may process multiple files in a single batch printing process. A user on a computer (not shown) attached to the MFP 20 may submit multiple files 30 or an archive 28 of multiple files 30 for processing by the MFP 20. Upon reception of the files 30, the MFP 20 determines if each file 30 in the batch or archive 28 is natively supported for outputting (printing). For each file 30 that is supported, the MFP 20 directly processes and output the file 30. For each file 30 that is not supported, the MFP 20 passes the file 30 for translation to an external translator 24. The non-supported file 30 is translated and passed back to the MFP 20, then processed and outputted as described above.

However, current MFPs are limited in their ability to handle and combine multiple files or documents. In the processes above, a MFP receiving multiple files or input is only able to output the files and inputs as multiple individual print jobs. Sometimes a user desires to combine multiple files into a single unified print job, taking advantage of the features of the MFP in doing so. For example, suppose a composite document to be printed contains several pages of text and several pages of drawings, but the drawing pages were generated as a separate document file by a special drafting program. Using the currently-available MFPs, a user could separately print the pages of text and the pages of drawings, but would not be able to intersperse pages of drawings in their proper places between the pages of text without manually recovering the two separate print jobs and manually inserting the figure pages in their proper places in between the text pages. Such a manual process also prevents the use of automatic finishing features available on some MFPs, such as automatic stapling. These burdens become especially onerous as the number of copies being printed increases.

Additionally, if the user desired special options such as duplex (2-sided) printing with a figure on one face of a sheet and a page of text on the other face of the sheet, such as printing option would be impossible short of printing the two pages separately and then copying the pages into a duplex format. Besides adding labor and time, such as multi-step process often adds additional imperfections into the final result, as copying or scanning may add unwanted marks from dust or other undesirable artifacts into the process, and may result in improperly aligned or twisted pages.

As another extreme example, suppose a collaborative report is to be printed using 4-up duplex printing (four pages printed per side of the sheet on both sides of the sheet). However, because the report is collaborative, different groups prepared different sections of the report as different files. Using a currently-available MFP, these files could not be merged or combined and printed together as a single document, but must be printed as separate print jobs. If each file contained nine pages to be printed, then massive amounts of white space would be included in the finished product, as a lone page from each file would be placed on a single face of a sheet in the report with a completely blank back of the sheet. Additionally, page reordering in such a situation is impossible without first printing all the pages full-size, ordering the pages, scanning the pages into a new file, and re-printing the complete job with the 4-up duplex options, with all the work and inherent imperfections generated by such a process.

In some instances, it is possible to perform such work on a computer workstation, combining and merging files into a single ordered document prior to accessing a printer of MFP. However, this destroys the advantages of walk-up hostless printing, and requires foresight and additional pre-printing steps. Additional advantages provided by MFPs may also be lost or unavailable, as such a process requires that all documents to be used in the pre-printing/pre-output process be available in softcopy format (i.e. contained in an electronic file), while MFPs are often able to work with both softcopy and hardcopy (i.e. contained on a sheet of paper) formats.

### BRIEF SUMMARY OF THE INVENTION

A method and apparatus is disclosed for receiving, combining, and processing multiple input jobs of multiple formats that may or may not be native to a multifunction peripheral (or multifunction printer or MFP) into a single composed output job in a format native to the MFP, which output job is then outputted. With the method and apparatus, more than one job (such as a document) is received at the MFP, the received jobs may be received by input devices of the MFP, and the received jobs originally may be in hardcopy format (such as to-be-scanned documents), or softcopy format (such as files on a USB flash memory device).

After jobs are received at the MFP, the jobs may be examined to determine which jobs, if any, are in a format native to the MFP, and which jobs, if any, are in a format not native to the MFP. Received jobs that are in formats not native to the MFP are passed to a translator, which converts the jobs into native formats. When all the jobs are in native formats, the jobs are then merged or combined into a single file by a merger. The entire process may be controlled according to default settings of the MFP or according to settings provided by a user of the MFP.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the embodiments of the invention will be described and explained with additional specificity and detail through the use of the accompanying drawings in which:

FIG. 1 shows a multifunction hostless printing environment in accordance with the prior art;

FIG. 2 shows a multifunction printing environment for printing multi-file archives in accordance with the prior art;

FIG. 3 shows a suitable hostless printing environment for practicing some embodiments of the present invention;

FIG. 4 shows a flowchart of a method of merging multiple documents into a single output job as a walkup process;

FIG. 5 shows a flowchart of an alternate method of merging multiple documents into a single output job as a walkup process;

FIG. 6 shows a flowchart of the process and results of processing by a documents translator;

FIG. 7 shows a flowchart of an alternate method of merging multiple documents into a single output job as a walkup process;

FIG. 8 shows a summary flowchart of the processes illustrated in FIGS. 4-7;

FIG. 9 shows a summary illustration of a walkup system for merging multiple documents into a single output; and

FIG. 10 shows another embodiment of a multifunction device.

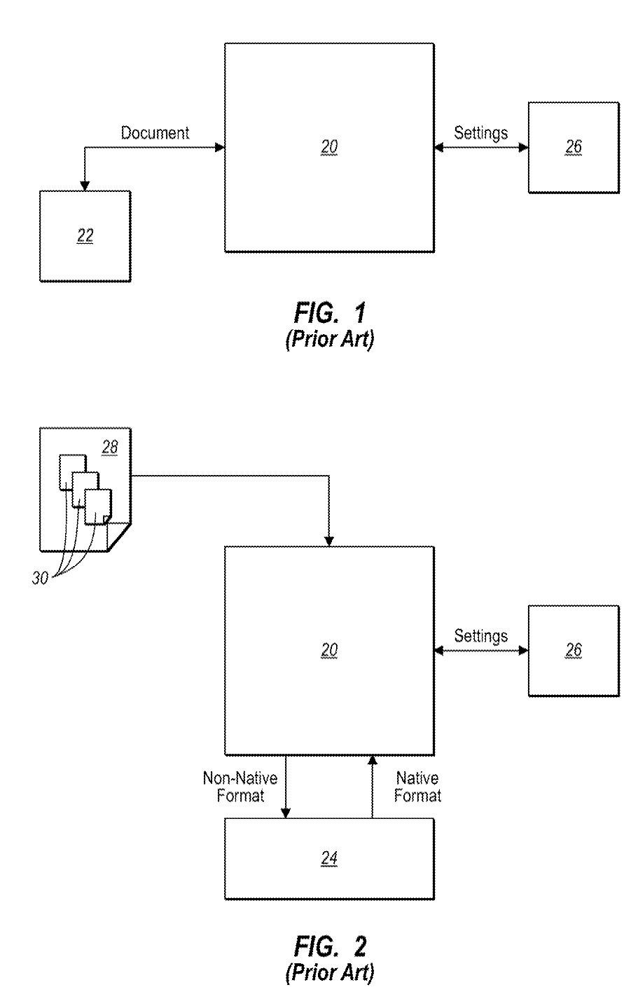

### DETAILED DESCRIPTION OF THE INVENTION

A description of the embodiments of the present invention will be given with reference to the Figures. It is expected that the embodiments of the invention may take many other forms and shapes, hence the following disclosure is intended to be illustrative and not limiting, and the scope of the invention should be determined by reference to the appended claims.

In the specification, and in the claims, the terms multifunction peripheral, multifunction printer, multifunction product, and MFP shall be interchangeable and shall mean a device that is capable of performing a variety of functions that might be carried out by separate peripheral devices. Devices so designated expressly include such devices configured to function as stand-alone devices not connected to a local or remote computer, server, or network, as well as devices connected to a local or remote computer, server, or network. Common functions that may be provided by a MFP include printing, faxing, and scanning.

In the specification, figures, and claims, the terms “multiple-page bitmap,” “multi-page bitmap,” “file in native format,” “document in native format,” and “native format” shall be interpreted broadly and interchangeably to mean 1) a document or file in an electronic format that is capable of being processed and interpreted on a page-by-page basis by a MFP as defined above, and 2) a document or file in a format capable of containing images or instruction to produce document images or text spread across multiple pages.

In the specification, figures, and claims, the terms “external translator” and “translator” shall be interchangeable and shall refer to hardware or software capable of receiving a document or file in one format and converting or translating the document or file into another format, specifically a native format as defined above. A translator or external translator so defined may be located as hardware or software as an integral part of a MFP or it may be located externally to a MFP.

In the specification, figures, and claims, the terms “jobs,” “print job,” “document,” and “file,” shall be interchangeable and shall refer to a single- or multiple-page document, picture, figure, or file capable of being displayed on a printed page or pages, and shall include both hardcopy and softcopy formats unless expressly limited to only either hardcopy and softcopy formats.

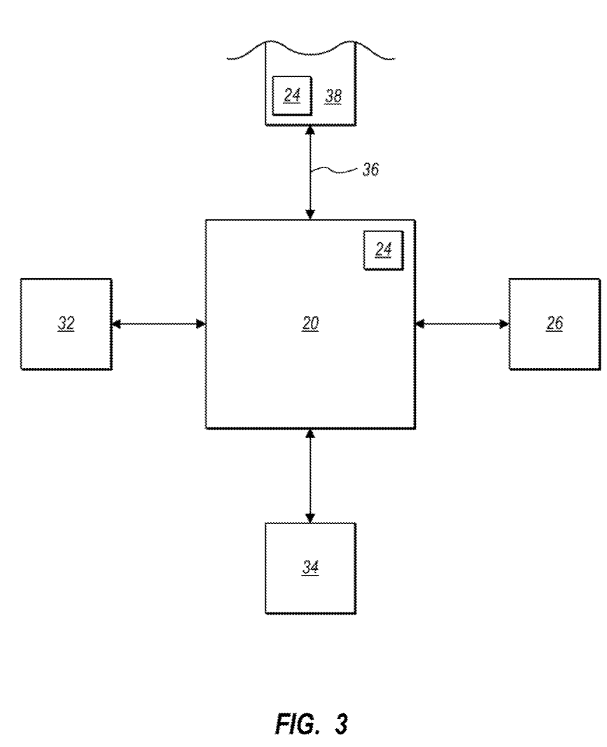

Some embodiments of the invention may be practiced in an operating environment depicted in FIG. 3. The operating environment includes a multifunction peripheral device 20 (as known as a “multifunction printer,” “multifunction product” or “MFP” and hereafter referred to as “MFP 20”). The MFP 20 is connected to a control panel 26 that allows a user to control the settings and input/output options of the MFP 20. The MFP 20 may be capable of performing certain functions, which may include copying, printing, scanning, faxing, and other similar functions. The MFP 20 may include a processor and memory (not shown) that allows the MFP 20 to store and process received documents and perform its other functions as described below. The MFP 20 also has one or more input devices and one or more output devices for use in performing its functions.

The MFP 20 is capable of receiving inputs 32 and producing outputs 34. The inputs 32 may be hardcopy, such as printed sheets or photos to be used in scanning or copying, or may be softcopy, such as electronic files contained on mass storage devices, received by facsimile, or received from a locally- or remotely-connected computer, from a handheld computing device, from a mobile device, or over a network. The outputs 34 produced by the MFP 20 may also be by hardcopy (such as in printing or copying), or may be in softcopy (as in scanning or faxing). Although the MFP 20 can function as a stand-alone unit without being connected to any other device or network, the MFP 20 may optionally be provided with a unidirectional or bidirectional communications connection 36 through a communications port (not shown) to an external device or network 38. The communications connection 36 may be continuous, such as a network connection, or may be intermittent, such as those used for facsimile transmissions.

The MFP 20 may be provided with a plurality of interface ports or mass storage drives (not shown) to allow the MFP 20 to communicate with mass storage devices and media currently known or developed in the future so as to allow a user to perform walkup input-output jobs without requiring the use of a host computer locally or remotely connected to the MFP 20. These interface ports and drives may serve to provide the inputs 32 to the MFP 20. As non-limiting examples of the ports and drives with which the MFP 20 may be provided, the MFP may be provided with a CD-ROM or CD-writable drive, a DVD-ROM or DVD-writable drive, a floppy disk drive, a USB port, A Firewire® (IEEE 1394) port, or any of the plurality of ports used with mass storage devices for digital cameras and other similar devices (a non-limiting list of currently-available devices include CompactFlash cards, secure digital (SD) cards, multimedia cards, Memory Stick cards, xD cards, PCMCIA cards, SmartMedia cards, and many others) or to connect to mobile devices such as handheld computers, cell phones, and the like. The MFP 20 may be provided with other ports for hostless inputs, such as email print, FTP print, and pull print from the control panel 26. One of skill in the art will readily recognize the large number of interface ports and drives that could be provided to allow access to mass storage devices, mobile devices, or media currently in use or developed in the future. Additionally, inputs 32 may be received over a network connection, a wireless connection, or an infrared connection, or from a locally- or remotely-connected computer device, as is known in the art, if the MFP 20 is connected to such devices by communications connection 36. For example, a user might be able to selectively access documents stored on an external storage device via the control panel 26. The MFP 20 may also be provided with short- or long-term storage capability to allow temporary or long term storage of files for use with some embodiments of the invention as inputs 32.

Various types of MFP 20 devices are envisioned as capable of serving the various functions described below. A non-exhaustive listing of devices capable of serving as MFPs 20 includes printers, facsimile devices, filing devices, format conversion devices, publishing devices, scanners, copiers, electronic whiteboards, audio/video devices, digital cameras, X-ray machines, MRI machines, CAT-scan machines, or any other device capable of receiving multiple inputs and providing a single combined output from the multiple inputs. In many devices, several of the above-listed devices are combined, such as an X-ray machine having an attached video device for display of the X-ray or an attached printer for printing out the X-ray.

In some embodiments, the MFP 20 may have access to external translators 24 that allow the MFP 20 to translate received inputs 32 from non-native formats to native formats that the MFP 20 is capable of outputting as part of a single output 34. As may be seen by reference to FIG. 3, in some embodiments, the external translators 24 need not be physically external to the MFP 20: in some instances the external translators 24 may be provided on the external device or network 38, if connected to the MFP 20; in other instances, the external translators 24 may be provided on hardware of the MFP 20, or may be running within a native or guest operating system on the MFP 20. In the later case, the external translator 24 may be stored on the same input media device or input media as the document in a non-native format and may be loaded with the document, and run within the native or guest operating system. Having the external translators 24 on the MFP 20 allows the MFP 20 to function as a freestanding unit even when non-native formats are encountered, and reduces the amount of data that would otherwise be passed through communications connection 36 even when the MFP 20 is not a freestanding unit.

Although one of skill in the art will recognize that many devices may be used in conjunction with embodiments of the present invention, the embodiments of the invention will be described in relation to one embodiment: a MFP 20 capable of receiving softcopy input from a mass storage device and providing outputs based on the received inputs and user-selected settings or default settings of the MFP 20. Specifically, an embodiment providing for walkup printing from a USB mass storage device will be described. In such an embodiment, a user can initiate a walkup print job from the MFP's control panel 26 as if the user were simply performing a copy job. The user inserts a USB mass storage device containing the electronic documents to print into the USB port on the MFP 20. The user then selects multiple documents to print as a batch job. The output from the job may be either a hardcopy output or a softcopy output. The MFP 20 then accesses the external translator(s) 24 for any documents selected that are in a non-native format, and those documents are converted into a native format. Once all documents are in a native format, the documents are merged into a single multi-page format in an order specified by the user. Then user-selected settings are applied to the format, and the output is generated.

As discussed above, the user may select various output settings from the control panel 26, may rely on default settings of the MFP 20, may rely on settings embedded within the document, or may perform some combination of the three. These settings include the order of documents in the single merged multi-page file. Additionally, the MFP 20 may allow the user to select other settings depending on setting availability on the MFP 20. By way of example and not limitation, the following are some settings that may be available on some MFPs 20: (1) Output Engine: copier, filing storage, outbound fax, and network scan; (2) Rendering: resolution, toner save, scaling, and rotation; (3) Sheet Assembly: N-up printing, booklet printing, reverse order, sheet insertion, sheet reordering, and blank page suppression; (4) Collation: copy collation, face up/down, and number of copies; (5) Finishing: staple, punch, trim, cut, and fold; and (6) Output Format: paper size/type, image format, OCR, compression, encryption, and security marks. In addition, the user may select to process some or all of the jobs as part of a single composition job, or may be provided with a selection to process some or all of the jobs as individual jobs as part of a batch job print.

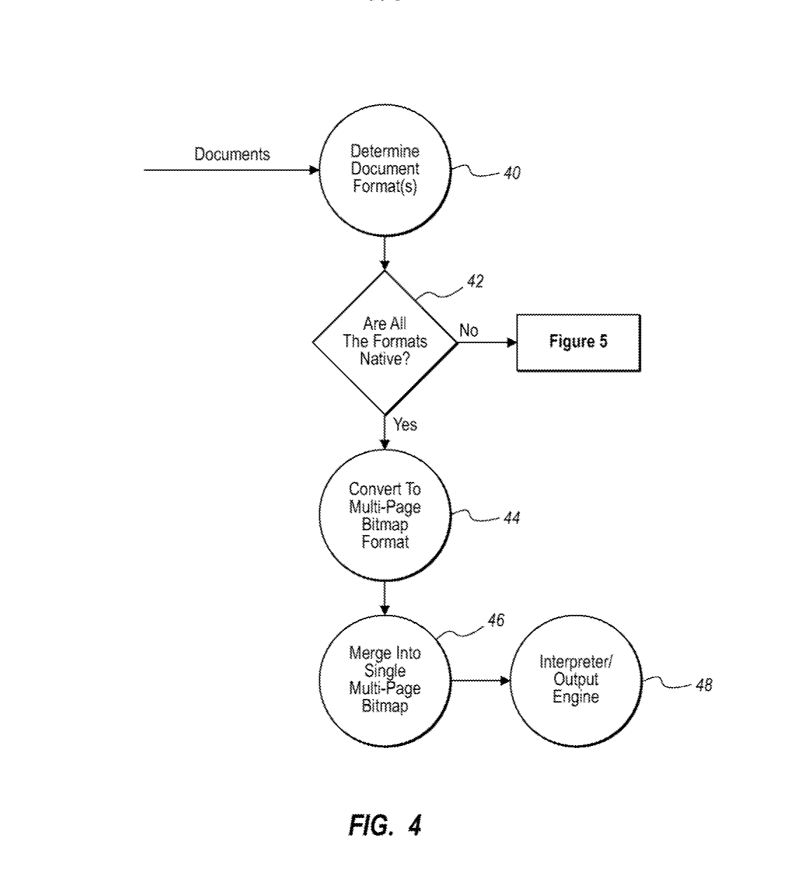

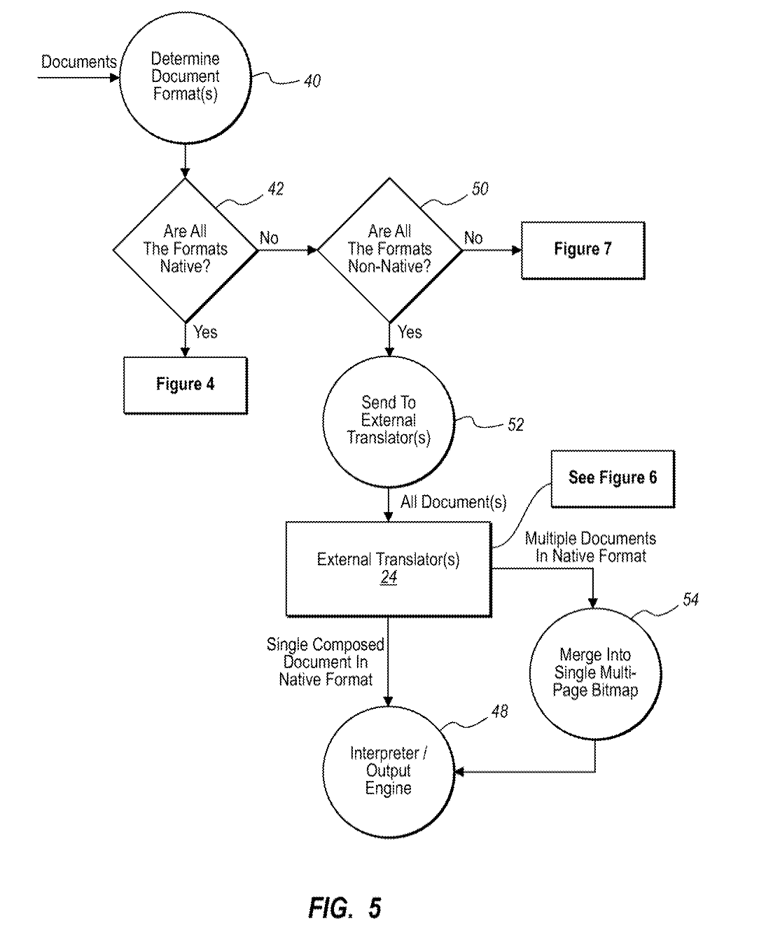

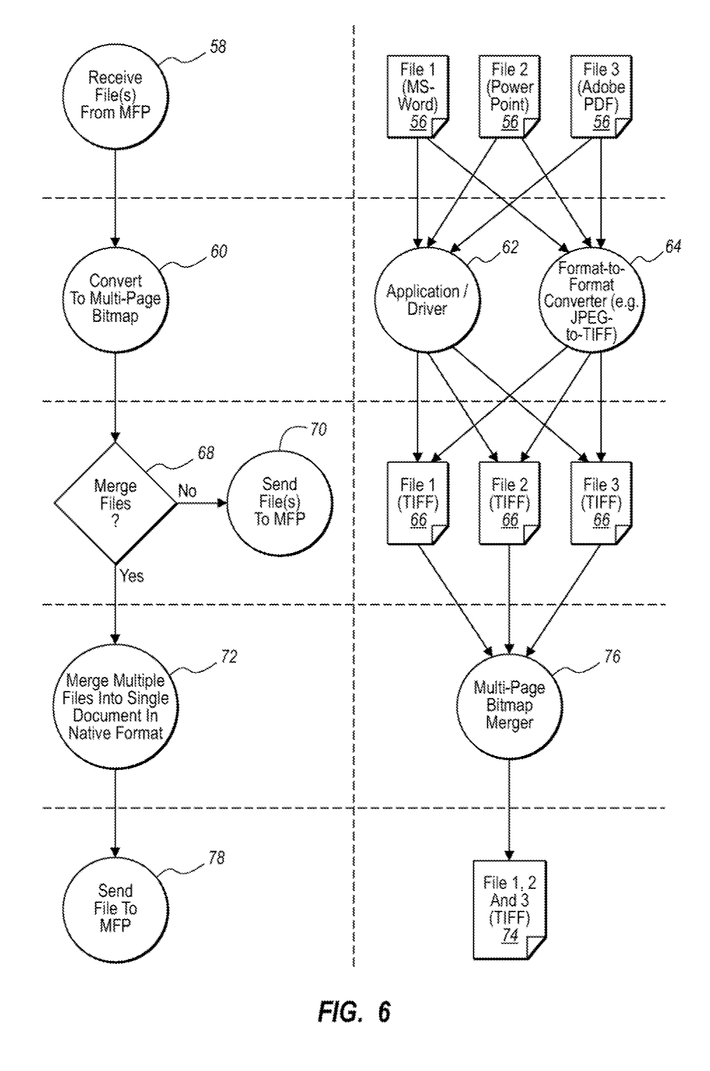

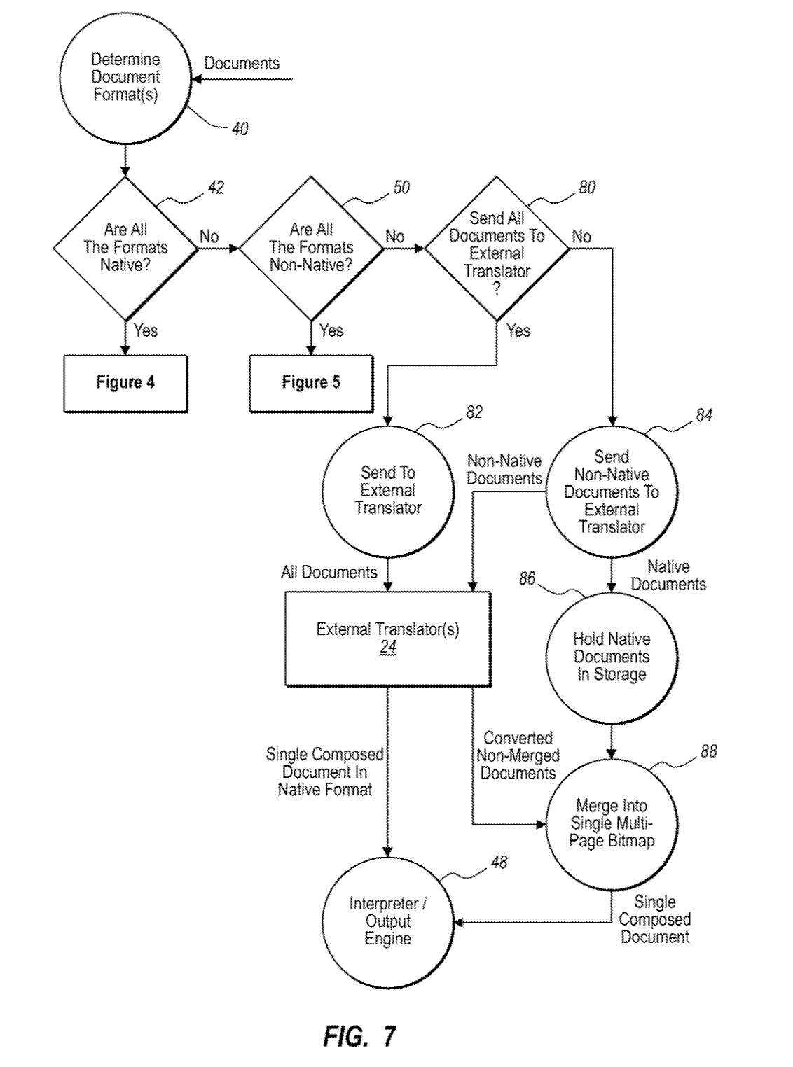

Thus, a MFP 20 configured to provide composition printing in the above fashion is quite flexible in its processing of multiple inputs 32 into a single or multiple outputs 34. This flexibility is increased in MFPs 20 that have the capability to scan documents, receive facsimile transmissions, or access remotely stored documents through communications connection 36. For example, if a user has several documents on a USB storage device, one hardcopy document, one document on a storage device on a computer connected to the MFP 20, and receives one facsimile transmission, all of these documents may be combined at and by the MFP 20, regardless of whether the formats of the various documents match or are even native to the MFP 20. One manner of forming a composition output job from various input documents will now be described in more detail with reference to FIGS. 4-8.

With reference to FIG. 4, after a user has selected to perform a merged composition print job, the documents are received by the MFP 20 and the MFP 20 attempts to determine the file format of each input file at Step 40. This may be accomplished by any means known in the art, such as by: (1) pulling the entire contents of the file onto the MFP 20 and analyzing the file to determine its file type, (2) pulling an initial header sequence of the file onto the MFP 20 and analyzing the header to determine its file type, and (3) obtaining other identifying information about the file, such as file suffix or metadata, and using this information to determine its file type. Next, at Decision Block 42, a decision is made as to whether the formats of the received document files are native formats. If the file formats are all native types, then the process proceeds to Step 44. If not, then the process proceeds as depicted in FIG. 5. When the document files are all native formats, the MFP 20 may perform the composition print wholly internally.

This is done at Steps 44, 46, and 48, as depicted in FIG. 4. The document files may be converted into a uniform compatible intermediate format at Step 44, such as: (1) a multiple-page image format such as TIFF, (2) a multiple-page document format such as PDF, (3) Display List (DL), or (4) a proprietary format. Next, at Step 46, the converted files may be merged into a single composed file in the document order specified by the user. At this time, user settings may be applied to reorder pages in the converted file, and the composed file may be converted into a streaming linearized format in preparation for printing or output. At Step 48, the composed file may be sent to an interperter or output engine for processing and outputting (printing), sometimes with additional user settings applied.

In some instances, some or all of the received document files are in non-native formats. In this instance, the MFP 20 may receive the document files, determine the document format at Step 40, and proceed to Decision Block 42 as before. However, as depicted in FIG. 5, at Decision Block 42 it is determined that not all the documents are in a native format, so the process proceeds to Decision Block 50, where it is determined whether all the documents are in non-native formats. If not all the document files are in a non-native format, then the process may proceed as depicted in FIG. 7. If all the documents formats are non-native, then all the document files may be sent to the external translator(s) 24 at Step 52. The document files are then processed by the external translator(s) 24 as discussed below in reference to FIG. 6, and the external translator(s) 24 may return the files as either multiple documents in native formats or as a single composed document in a native format, as depicted in FIG. 5. If the external translator(s) 24 return multiple documents, execution proceeds to Step 54, where the multiple files are merged into a single multi-page bitmap, formatted as discussed previously with reference to Step 46, and then sent to an interpreter or output engine for processing and outputting at Step 48. In the case where the external translator(s) 24 return a single composed document file, execution may proceed directly to processing and outputting at Step 48, as depicted in FIG. 5, or additional processing may be performed by the MFP 20.

The processing performed by the external translator(s) may be understood by reference to FIG. 6. The MFP 20 may send all the files to the same external translator 24 for conversion into a format that is native to the MFP 20, or the MFP 20 may send different files to different external translators 24 for conversion. The MFP 20 may identify the available external translators 24 by any means, such as: (1) being predefined in the MFP, such as being entered by an administrator, (2) being dynamically specified by the user, (3) being dynamically discovered by the MFP 20, such as by broadcast request, or (4) being pre-registered in the MFP 20 by the external translators 24. In FIG. 6, the left side depicts the process performed by the external translator(s) 24, while the right side depicts the files as they proceed through the process and the agents within the external translator(s) 24 performing the conversion.

First, the external translator 24 receives files 56 in non-native formats at Step 58. Execution then proceeds to Step 60, where the files 56 are converted or translated into a native format or multi-page bitmap. This Step 60 is performed by an application/driver 62 or a format-to-format converter (such as a transcoder) 64. The result of this translation Step 60 is files 66 in native formats, such as TIFF, other multi-page bitmap formats, or other formats native to the MFP 20. When the application/driver 62 is used, the translator 24 uses a format specific application to interpret the document and convert it into device-independent graphical primitives, such as GDI. The device-independent graphical primitives are then converted by a format-specific driver, such as a TIFF driver, into a format native to the MFP. The format-to-format converter 64 may be a direct format-to-format converter such as a JPEG-to-TIFF converter.

After conversion by the application/driver 62 or the format-to-format converter 64, execution then proceeds to Decision Block 68, where it is determined if the files 66 in native formats should be merged by the external translator 24. If not, execution proceeds to Step 70, and the files 66 in native formats are sent individually to the MFP 20 for merging and further processing. However, if merging by the translator 72 is to occur, execution proceeds to Step 72, where the files 66 in native format are merged into a single merged file 74 or document in native format by a merger 76. Finally, at Step 78, the merged file 74 is returned to the MFP 20.

When document files are sent to the external translator(s) 24 in this way, the merging of the converted documents may occur in several ways. First, if all the documents were sent to the same translator 24, the documents may be merged at the translator 24. Second, if the documents were sent to multiple translators 24, each translator 24 may merge the documents if received, and then the MFP 20 receives multiple merged documents and merges these documents in a second merging step. Third, if the documents were sent to multiple translators 24, the translators 24 may communicate between themselves, with the translators 24 sending the various documents to a single translator 24 for merging. Fourth, regardless of the number of translators 24 used, the translators 24 may merely send the converted documents back to the MFP 20 without performing any merging, and the MFP 20 performs any merging necessary. In any event, the merging process may include processing according to the user-defined settings, such as merge order, page reordering, and other output options, as discussed above prior to outputting the merged and processed file to the interpreter/output engine 48.

In cases where the MFP receives documents with a mix of native and non-native formats, execution may proceed according to FIG. 7. After documents are received by the MFP 20 and the document format(s) are determined at Step 40, execution proceeds through Decision Blocks 42 and 50, where it is determined that not all the document formats are native and not all the document formats are non-native. At that point, execution proceeds to Decision Block 80, where it is determined whether to send all the documents to the external translator(s) 24. If the answer is affirmative, execution proceeds to Step 82 and all the documents, native and non-native alike are sent to the translator(s) 24. In this situation, execution at the translator(s) proceeds as previously discussed in reference to FIGS 5 and 6, with the exception that documents already in a native format need not necessarily be converted to a different format.

If, however, it is decided at Decision Block 80 not to send all the documents to the translator(s) 24, execution proceeds to Step 84, where documents in a non-native format are sent by the MFP 20 to the translator(s) 24. While the translator(s) 24 are performing their functions, the MFP 20 may hold the documents that are already in native format in storage as at Step 86. The MFP 20 may wait synchronously or asynchronously for the translator(s) 24 to perform their functions and to return the converted files. In the latter case, the MFP 20 and external translator(s) 24 may use a job/file-specific identifier to identify the file(s) and the associated print job when the translated file(s) are received. After the translator(s) 24 have performed the translation of the documents in non-native format(s) into documents in native format(s) in a fashion similar to that previously described with reference to FIG. 6, execution proceeds to Step 88. At this Step 88, the various documents are received from the translator(s) 24 and retrieved from storage and merged into a single file in native format and processed as previously described. At Step 48, the composed file may then be sent to the interpreter or output engine for processing and outputting, also as previously described.

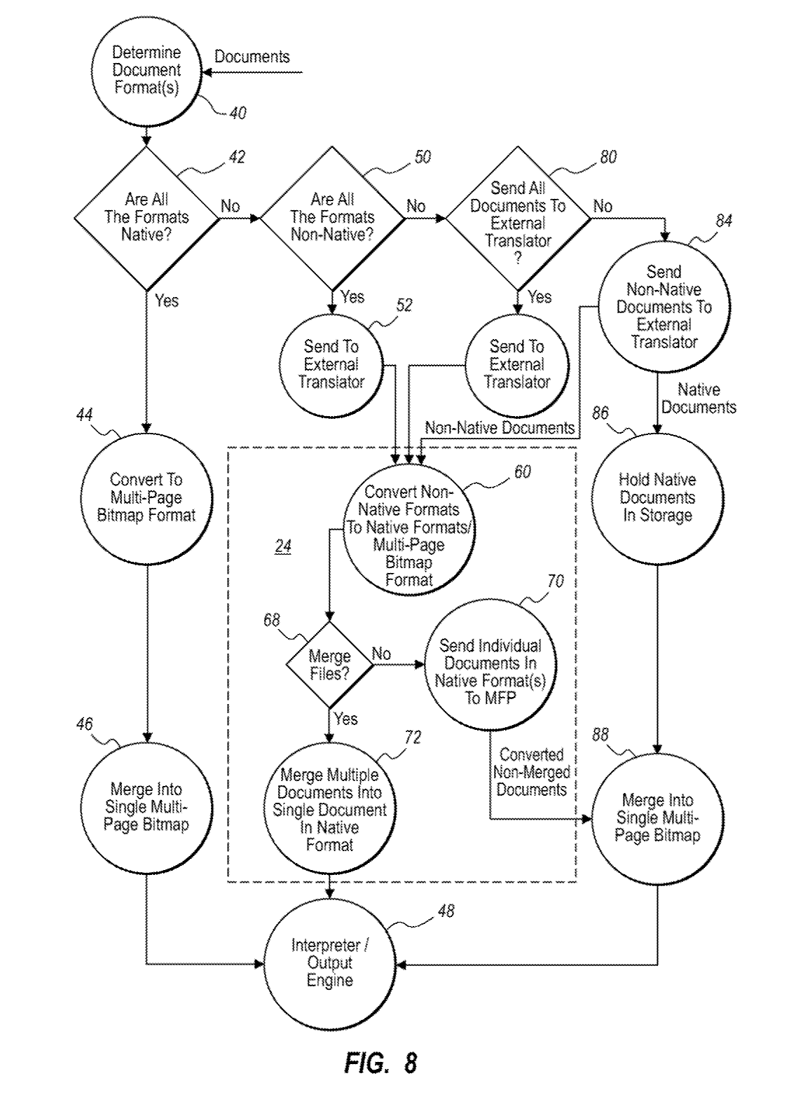

FIG. 8 depicts a summary flowchart showing the various Steps depicted in FIGS. 5-7. As may be seen by reference to this Figure, merging multiple print jobs as part of a single walkup print job may proceed entirely without using the external translator(s) 24, or it may proceed with some or all of the documents being received and processed by the translator(s) 24. Furthermore, as may be appreciated from the previous discussion, in situations where the MFP 20 contains the external translator(s) 24, the entire process depicted in FIG. 8 may proceed on a standalone MFP 20 without any connection to an external server, network, or local or remote computer. In other embodiments, the external translator(s) 24 may be located externally to the MFP 20, and the MFP 20 may utilize a connection to the translator(s) 24 to pass and receive documents for processing. While some of the details depicted in FIGS. 4-7 have been omitted from FIG. 8, FIG. 8 provides a good summary of some of the steps that may be used by a MFP 20 in accordance with embodiments of the present invention.

While the above-described embodiments have been discussed with respect to taking multiple softcopy sources and combining them into a single hardcopy output, it should be recognized that a mix of hardcopy and softcopy inputs and outputs may be used. For example, the documents and/or files to be combined may include some softcopy documents, scans of hardcopy documents that become input sources for the composition output job, inbound faxes, or any other currently known or future-inverted document format or image. Similarly, the composition output job need not be a hardcopy job, but might also be a softcopy job including a filing job, an outbound fax, or a saved combined file to a local, remote, or removable storage destination.

While the above-described embodiments have been discussed with respect to inputting documents from a hostless source as a walkup job, the input sources may be non-walkup (e.g., email print, where jobs for printing are received in an e-mail from a PDA, cell phone, or other mobile device) hostless sources, as well as remote hosted sources (e.g., PC print).

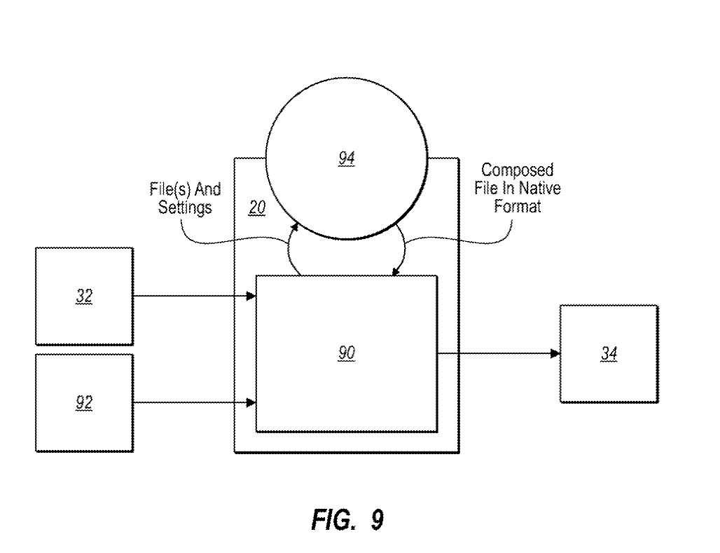

FIG. 9 depicts a high-level summary of the processes performed by the MFP 20 in accordance with embodiments of the present invention. The MFP 20 has an input-output end 90 that receives input(s) 32 in any of the various formats discussed above and settings 92. The MFP 20 input-output end 90 then passes the files (either the input(s) 32 or generated from the input(s) 32) and settings 92 received to a data processing end 94 that may be entirely located on the MFP 20, or may be partially or totally located externally to the MFP 20. The data processing end 94 then converts and merges the files as necessary according to the received settings 92. When the processing has been completed, the data processing end 94 passes the composed and merged file(s) back to the input-output end 90, and the input-output end 90 then provides the output(s) 34 in whatever form is dictated by the settings 92, as discussed above.

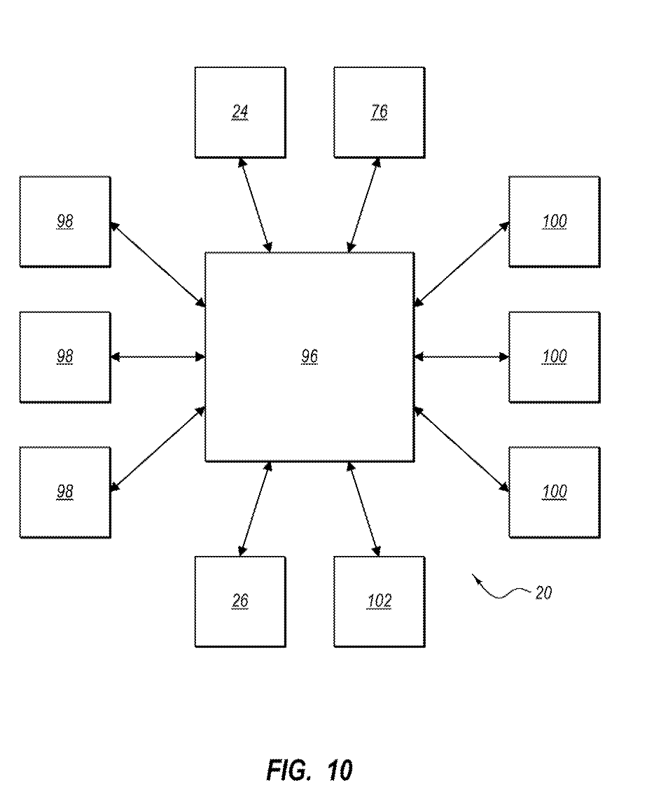

FIG. 10 illustrates one embodiment of an MFP in accordance with the present invention. The illustrated embodiment includes a processor 96 communicatively coupled to one or more input devices 98 and one or more output devices 100. The input devices 98 may include scanners, ports, drives, communications connections or ports, or any other such device known in the art. The output devices 100 may include laser, inkjet, dye sublimation, impact, or any other printing devices, output ports, drives, communications connections or ports, or any other such device known in the art. The input device or devices 98 receive the various input jobs to be processed and merged, and the output device or devices 98 output the processed and merged output jobs. Also communicatively coupled to the processor 96 are the control panel 26 for receiving user instructions and settings, the translator 24 for converting received inputs from non-native formats to native formats, and the merger 76 for merging multiple documents or files into single documents or files. Additionally, communicatively coupled to the processor 96 is memory 102, which is used by the MFP 20 to store files during the processing, conversion, and merging of documents to produce the output job. In some embodiments, all of the various elements depicted in FIG. 10 may be contained within a single housing (not shown). In other embodiments, one or more of the elements depicted in FIG. 10 may be provided in separate housings or devices communicatively coupled to the MFP 20. The communicative coupling may be by a wired electrical connection, or it may be provided by a wireless connection such as a radiofrequency connection or infrared connection, or by any other communicative connection known in the art.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A multifunction apparatus for combining and processing multiple input jobs into a single output job, the apparatus comprising:
an input device capable of receiving an input job;
an output device capable of outputting an output job;
a plurality of input jobs, wherein at least one of the input jobs is received at the input device;
memory capable of storing the plurality of input jobs during processing and merging of the plurality of input jobs;
a translator configured to receive input jobs selected from the plurality of input jobs that are in a format not native to the multifunction apparatus and further configured to convert the selected input jobs into a format native to the multifunction apparatus;
a merger capable of receiving the plurality of input jobs and merging the plurality of input jobs into a single output job;
a control panel configured to receive user inputs corresponding to instructions for processing and merging the plurality of input jobs into the single output job; and
a processor communicatively coupled to the input device, to the output device, to the memory, to the translator, to the merger, and to the control panel and configured to process and direct reception, storing, conversion, and merging of the plurality of input jobs and outputting of the single output job, all according to the user inputs received at the control panel.

2. The apparatus of claim 1 wherein the input device, the output device, the memory, the translator, the merger, the control panel, and the processor are all located in a single housing.

3. The apparatus of claim 1 wherein at least one of the input device, the output device, the memory, the translator, the merger, the control panel, and the processor is located in a separate housing.

4. The apparatus of claim 1 wherein:
the input device is a device selected from the group of a scanner, a communications port configured to receive a mass storage device, a media drive, a communications port configured to connect to a network, a communications port configured to connect to an external computer, a communications port configured to receive a facsimile transmission, a communications port configured to connect to a mobile computing device, a communications port configured to connect to a mobile communications device, a communications port configured to connect to a camera, a wireless data communications device, and an infrared communications device; and
the output device is a device selected from the group of an impact printer, a laser printer, an inkjet printer, a dye sublimation printer, a communications port configured to receive a mass storage device, a media drive, a communications port configured to connect to a network, a communications port configured to connect to an external computer, a communications port configured to transmit a facsimile transmission, a communications port configured to connect to a mobile computing device, a communications port configured to connect to a mobile communications device, a communications port configured to connect to a camera, a wireless data communications device, and an infrared communications device.

5. The apparatus of claim 1 wherein at least one of the plurality of input jobs is in a format not native to the multifunction apparatus.

6. The apparatus of claim 1 wherein the translator comprises a format-to-format converter.

7. The apparatus of claim 1 wherein the translator comprises a format-specific application and a format-specific driver.

8. A method for combining and processing multiple input jobs having multiple formats into a single composed output job in a format native to a MFP, the method comprising:
providing a MFP having at least one input device, at least one output device, and a control panel;
receiving a plurality of input jobs at the MFP;
receiving instructions generated by a user of the MFP, the instructions comprising:
directions for combining the plurality of input jobs into a single output job; and
settings for outputting the output job;
determining if any of the plurality of input jobs are in a format not native to the MFP;
converting, at a translator, any of the plurality of input jobs that are in a format not native to the MFP into a format native to the MFP;
combining the plurality of input jobs at the MFP into the single output job according to the directions for combining; and
outputting the output job according to the settings for outputting.

9. The method of claim 8 wherein the MFP is a standalone device capable of performing the method without relying on an external computing device.

10. The method of claim 8 wherein the plurality of input jobs comprises both hardcopy and softcopy input jobs.

11. The method of claim 8 wherein the directions for combining comprise ordering instructions for arranging the plurality of input jobs into an order within the output job.

12. The method of claim 8 wherein the settings for outputting comprise at least one of page reordering instructions, output format instructions, facsimile transmission instructions, file format instructions, resolution instructions, toner use instructions, scaling instructions, rotation instructions, print quality instructions, scaling instructions, rotation instructions, N-up printing instructions, booklet printing instructions, reverse order instructions, sheet insertion instructions, blank page suppression instructions, copy collation instructions, face up/down instructions, number of copies instructions, stapling instruction, punching instruction, folding instructions, page size instructions, paper type instructions, and page reordering instructions.

13. The method of claim 8 wherein the translator is located on the MFP.

14. The method of claim 8 wherein the translator is located externally to the MFP.

15. The method of claim 8 wherein all of the plurality of input jobs are sent to the translator and the translator performs the steps of:
converting any of the plurality of input jobs that are in a format not native to the MFP into a format native to the MFP; and
combining the plurality of input jobs at the MFP into the single output job according to the directions for combining.

16. The method of claim 8 further comprising displaying the output job to the user to permit the user to enter additional settings and instructions for processing and outputting the output job.

17. A method for walkup combining and processing of multiple input jobs into a single composed output print job at a MFP, the method comprising:
providing a MFP having at least one input device, at least one output device, and a control panel;
receiving a plurality of input jobs at the MFP, wherein at least one of the input jobs is received via the input device from a user at the MFP at a time temporarily proximate the time of printing;
receiving instructions from the user through the control panel of the MFP, the instructions comprising:
directions for combining the plurality of input jobs into a single composed output print job; and
settings for outputting the output print job;
determining if any of the plurality of input jobs are in a format not native to the MFP;
sending at least the input jobs that are in a format not native to the MFP to a translator;
converting, at the translator, any of the plurality of input jobs that are in a format not native to the MFP into a format native to the MFP;
combining the plurality of input jobs into the single composed output print job according to, and in an order directed by, the directions for combining; and
printing the output print job according to the settings for outputting.

18. The method of claim 17 wherein the MFP is a standalone device capable of performing the method without relying on an external computing device and wherein the translator is located on the MFP.

19. The method of claim 17 wherein the plurality of input jobs comprises both hardcopy and softcopy input jobs.

20. The method of claim 17 wherein all of the plurality of input jobs are sent to the translator and the translator performs the steps of:
converting any of the plurality of input jobs that are in a format not native to the MFP into a format native to the MFP; and
combining the plurality of input jobs into the single composed output print job according to, and in an order directed by, the directions for combining.
